(19) United States
(12) Patent Application Publication
(10) Pub. No.: US 2007/0131720 A1
(43) Pub. Date: Jun. 14, 2007

(54) Processes and apparatuses for dosing a medicament or other viscous substance

(75) Inventors: David Bromert, Liberty, MO (US); Randy Brian Wroten, Greenwood, DE (US); Daniel Beauchamp, Saint Lazare (CA)

Correspondence Address: INTERVET INC.;PATENT DEPARTMENT, PO BOX 318, MILLSBORO, DE, 19966-0318, US

(73) Assignee: Akzo Nobel N.V., Arnhem (NL)

(21) Appl. No.: 10/577,125

(22) PCT Filed: Oct. 27, 2004
(86) PCT No.: PCT/US04/36007

§ 371 Date: Apr. 26, 2006

Related U.S. Application Data
(60) Provisional application No. 60/515,946, filed on Oct. 29, 2003.

(51) Int. Cl. B67D 5/40

(52) U.S. Cl. 222/372

(57) ABSTRACT

Various embodiments of the present invention generally related to a dosing system, and a process for dosing a substance into animal feed.

### BACKGROUND

The art field is filled with numerous examples of dosing applicators. These various devices are for dosing a wide variety of substances, from liquids to powders and every viscosity in between. As such, a wide variety of applicators have emerged. For example:

U.S. Pat. No. 5,203,508 (hereinafter referred to as the '508 patent) discloses a dosing applicator comprising a revolving valve element, arranged fixedly in a first casing which is immovably connected with the gun housing. The first casing has a second spring-loaded casing linked to it in a mobile way, which contains a hollow cylinder having on its frontal part valve seats. The dosing applicator can operate with or without a supply of compressed air. However, the dosing applicator of the '508 patent does not have adequate features to prevent leakage of the fluid being applied and/or dispensed.

U.S. Pat. No. 4,982,899 (hereinafter referred to as the '899 patent) discloses a device for controlling the quantity of a fluidic substance emerging from a discharge nozzle of an equipment which device includes a delivery chamber extending between the discharge nozzle and a pump housing which has a pump chamber connected at one end by an outlet valve to the delivery chamber and receives a reciprocating pump piston, with the delivery chamber including a control arrangement that will adjust the quantity of the medium flowing through the discharge nozzle and also prevent a dribble from the end of the nozzle during a return stroke of the pump piston. The control arrangement includes a control sleeve which telescopically receives the control piston that moves with the valve member of the outlet valve relative to the sleeve and the sleeve and control piston have a flow restricting arrangement, such as formed by a groove having a different cross sectional size in the axial direction so that the size of the opening will change as the control piston moves relative to the control sleeve. However, this device does not allow for a measured quantity of the fluidic substance to be dispensed. Accordingly, the art field is in search of a device with the adjustable controls of the '899 patent, but which also allows a measured delivery of a medicament or other fluidic substance.

U.S. Pat. No. 4,735,362discloses an apparatus for delivery of a liquid by a pump that only discharges when the desired pressure is applied. While the benefits of such a device are apparent, the device does not have the safety features of preventing accidental or incidental releases of the fluidic substance.

U.S. Pat. No. 5,492,426 discloses an applicator including a reservoir containing a substance to be applied, a cap intended to close the reservoir and supporting a stopper including an applicator holder supporting a deformable element for applying the substance. The deformable element has a shape memory, i.e., can return to its original shape after being deformed, and a roughened surface. The reservoir holding the substance includes an end-piece having a base equipped with a seat including at least one capillary orifice against which the deformable element deforms when the reservoir is closed by the cap.

U.S. Pat. No. 5,843,052 discloses a compact open irrigation kit that may be connected to a hose. While this device allows for the controlled delivery of a fluidic substance for flushing wounds, the device fails to provide for a measured delivery of the fluidic substance. Accordingly, the art filed is in search of a device for delivering a fluidic substance.

U.S. Pat. No. 5,938,640 (hereinafter referred to as the '640 patent) discloses a fluid dispensing device. However, this device is designed for the delivery of very small amounts of fluid in a medical or ambulatory situation. Further, the device has not provisions for manual delivery of a measured dose.

The shortfalls and problems of the prior art are addressed by the present invention. For a more complete understanding, attention should be had to the following Claim and description.

### SUMMARY

Generally, embodiments of the present invention relate to a dosing gun system comprising a first portion, a second portion, and a third portion for application of a viscous fluid, and related methods and/or processes of use. Embodiments of the invention generally comprise safety features designed to substantially prevent leakage of the viscous substance from the system. Further embodiments of the system of the present invention allow for the repeated delivery of a certain dose of viscous liquid.

Further embodiments of the present invention comprise methods for delivering a fluidic substance with the various devices of the present invention.

Nothing in this Summary should be considered as a limitation. For a complete understanding of the disclosure and meaning of the Claims, attention should be had to the following Detailed Description and Examples.

### BRIEF DESCRIPTION OF THE FIGURES

FIG. 1 is an illustration of an embodiment of a dosing system of the present invention.

FIG. 2 is an illustration of an embodiment of a dispenser or dispensing means of the present invention.

FIG. 3 is an illustration of an embodiment of a connector of the present invention.

FIG. 4 is an illustration of an embodiment of a quick disconnect of the present invention.

### DETAILED DESCRIPTION

Various embodiments of the present invention generally comprise three portions; a first portion, a second portion, and a third portion. In its broadest interpretation, the present invention comprises a dosing system for applying and/or delivering a viscous fluidic substance comprising a receptacle means, a connection means, and a dispensing means and related processes and methods for use, further explained below. The three portions cooperate as a dosing system or gun for application of a viscous fluid. In general, the viscous fluid is drawn from a receptacle and applied from the end of a nozzle, as will be explained in greater detail below.

Accordingly, as will be explained through this disclosure, embodiments of the present invention comprise A dosing system comprising a receptacle means, a connection means, and a dispensing means, wherein the first portion is a receptacle means capable of holding the substance, the second portion is a quick disconnect cap means capable of substantially preventing leakage of the substance being dispensed, and the third portion is a dose applicator means for the substance, wherein the second portion comprises a male connector and a female connector, wherein the male portion removable attaches to the first portion and the female portion sealingly attaches to the third portion, wherein the first or the third portion can be removed from the system without allowing the viscous substance to leave the system.

Further embodiments comprise a dosing applicator means comprising a dispensing nozzle means for dispensing the viscous substance, a dose container means for containing a dose of the viscous substance, and a trigger means connected between the second portion and the dose container for allowing the viscous substance to flow into the dose container from the receptacle means.

It should be noted that the use of the term viscous is not meant as a limitation on the substances which may be applied with the varying embodiments of the present invention. Every fluid has a viscosity.

Further, the use of the term fluid is not limited to a liquid fluid. The term fluid can be a gas or a liquid/liquid-like material.

Further, the term fluidic substance comprises a substance comprising a fluid as herein defined. Therefore, a fluidic substance of the present invention comprises, but is not limited to liquids, gases, amorphous materials, liquids with solids dispensed therein, pastes, gels, and/or the like.

The fluid may be any additive common in the art, such as a neutraceutical, pharmaceutical, vitamin, mineral, and the like. In an embodiment, the fluid is a progesterone containing fluid, such as, but not limited to altrenogest.

In various embodiments, the viscous fluid can be applied directly on the animal. In other embodiments, the viscous fluid is applied to a feed of the animal. While in other embodiments, the viscous fluid is applied to a drinking water source for the animal. In general, the viscous may be applied in any manner common in the art.

In various embodiments, the first portion 1, as shown in FIG. 1, is a receptacle capable of holding a viscous substance. In an embodiment, the receptacle comprises a plastic or other polymeric material capable of being formed. However, in other embodiments, the receptacle may be any material common in the art. Reference to FIG. 1 illustrates a receptacle 1. Receptacle 1 may be in any orientation, such as horizontal, vertical, titled, and the like. FIG. 1 illustrates a receptacle 1 in a horizontal orientation. Various embodiments utilize a receptacle 1 capable of a vertical orientation which may further comprise an air intake or breather/breather valve to assist in preventing a vacuum on the viscous substance in receptacle 1.

In embodiments, the second portion 2, as shown in FIG. 1, is a connection or connector connecting the first portion and the second portion. Portion 2 may be any number of connectable pieces. In an embodiment, portion 2 is at least two (2) pieces.

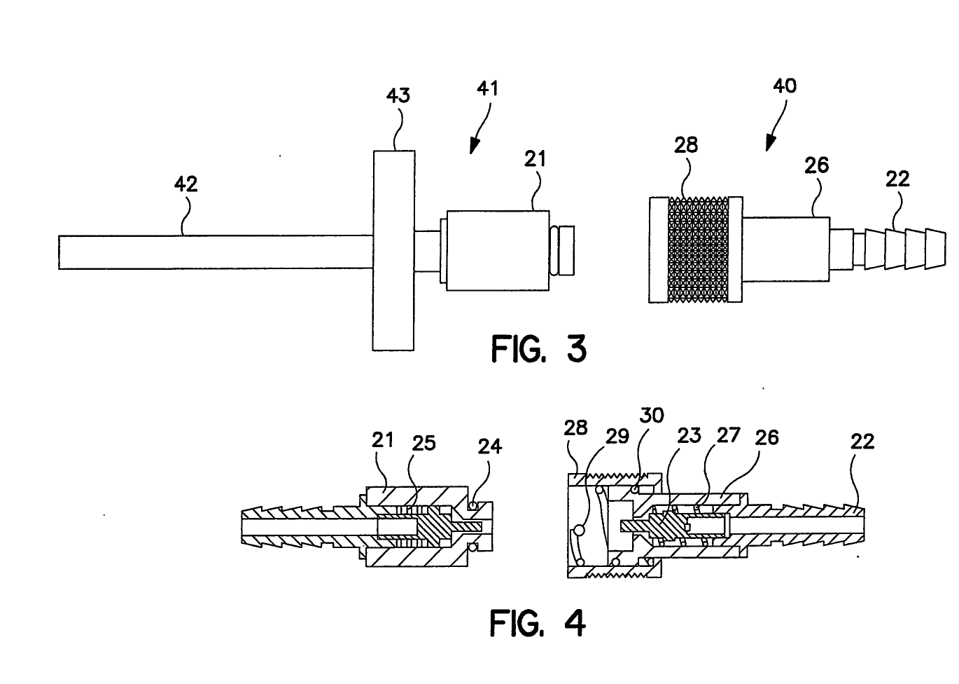

Reference to FIGS. 3 and 4 illustrate a second portion 2 comprising two pieces. In general, a two portion embodiment comprises a left side 41 and a right side 40, as illustrated in FIG. 3. In various embodiments, portion 2 comprises a male connector and a female connector, wherein the male portion removably attaches to the first portion and the female portion sealingly attaches to the third portion, wherein the first or the third portion can be removed from the system without allowing the viscous substance to leave the system.

In the embodiment of FIGS. 3 and 4, side 40 and side 41 comprise a quick disconnect second portion 2. However, any type of connection between sides of portion 2 may be used such as screw-on, interference fit, tap-on, and any other connection common in the art. Further, various types of quick disconnects may be used, such as a push/release latch mechanism or twist to connect/pin release system. The embodiment illustrated is a twist to connect/pin release system.

In general, various embodiments of a twist to connect/pin system comprise a coupling 28 housing a dowel pin 29. Left body 21 and right body 26 are connected by the releasable mating of coupling 28 and a portion of left body 21. In an embodiment, left side 41 comprises a left body 21 an O-ring 24, a left spring 25, and a left fitting 44. In the embodiment, right side 40 comprises a large spring 30, valve 23, right spring 27, and a right fitting 22. In operation of this embodiment, a connection is formed when left side 21 is inserted and twisted in coupling 28. Release may occur when left side 21 and coupling 28 are twisted and pulled apart.

In an embodiment, left spring 25 operates to bias and close left side 41 when disconnected from side 40. Likewise, right spring 27 operates to bias and close right side 40 when disconnected from side 41. This disconnection provides a safety and prevents the flow of substantially any fluid through left side 41 or right side 40 after disconnection. In a preferred embodiment, the tension of spring 25 is less than the tension of spring 27, thereby allowing a fluid to flow more readily across left side 41, and, for instance, back into receptacle 1. The operation of such safety devices will be discussed more fully in reference to operation of a preferred embodiment below. Suitable quick connection devices would be comparable to the ones illustrated in U.S. Pat. Nos. 5,494,074; 6,161,578; 5,639,064; 4,934,655; and, U.S. application Ser. No. 10/025,236, published under Pub. No.2002/0074533 A1. Suitable valves and/or connections may also be purchased from Colder Products, 1001 Westgate Drive, St. Paul, Minn. 66114. However, various modifications to the afore of ordinary skill in the art and are intended to be covered by this disclosure.

Referring back to FIG. 3, left side 41 is illustrated connected to a receptacle closure 43 with a straw 42 extending therethrough. Cap Closure 43 may be any structure common in the art for closing a receptacle, such as a screw on lid, tap on lid, interference fit lid, and the like. In a preferred embodiment, a straw 42 extends from cap closure 43 into receptacle 1 (not illustrated in FIG. 3). Straw 42 aids in the removal of the viscous fluid from receptacle 1

Referring back to FIG. 1, portion 2 is illustrated connected to portion 1 and portion 3. Such connections may be by any means common in the art, such as screw-on, interference fit, tap-on, hose barb, and any other connection common in the art. In various embodiments, portion 2 may be connected to a tube or tubes that are connected to portion 1 and/or portion 3. In an embodiment, tube 14 connects from portion 2 to portion 3. Tube 14 may be constructed of any material and be of any diameter. In an embodiment, tube 14 is a plyable material, such as a plastic.

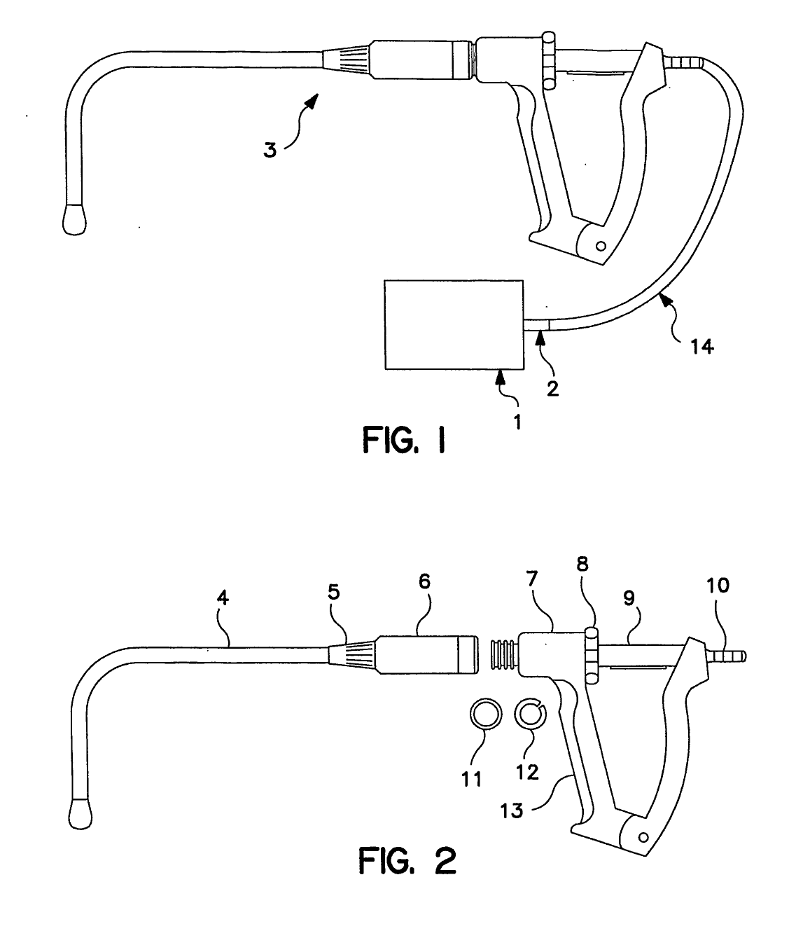

Referring to FIG. 2, and illustration of a dosing gun, portion 3. Portion 3 may be any suitable appendage for dispensing a viscous substance, such as a fluid, such as a trigger/release mechanism, a valve, a screw on containment, a push on cap, and the like. In a preferred embodiment, portion 3 is a gun with a trigger to allow the flow of viscous fluid from receptacle 1. Such trigger mechanisms are common in the art.

In an embodiment, an embodiment of the dosing applicator comprises a dispensing nozzle for dispensing the viscous substance, a dose container for containing a dose of the viscous substance, and a trigger connected between the second portion and the dose container for allowing the viscous substance to flow into the dose container from the receptacle.

In another embodiment, portion 3 comprises a dosing gun. The dosing gun comprises a grip 13, a connection 10, a piston 9, a nozzle 1, and a gun comprising generally 0-ring and/or sealing members 5, handle 7, barrel 3, nozzle cap 2, and sealing members/washers 11 and 12. In an embodiment of this type, nozzle 4 is bent at an angle extending away from barrel 3, explained below under the description of the operation of the preferred embodiment. Nozzle 4, in an embodiment, is connected to barrel 3 and handle 4 with a nozzle cap 2 and various washers and/or sealing members 8 and/or 9, as will be readily apparent to those of ordinary skill in the art.

In various embodiments, barrel 3 comprises a dosing chamber. In an embodiment, such dosing chamber has a fixed volume. The fixed volume chamber allows for the repeated delivery of a certain/known measurement to multiple applications. In other embodiments, the volume of barrel 3 may be modified and adjusted for delivery of a precise volume. The volume adjustments may be made by changing the size of barrel 3 by a screw like member, installation of a different sized barrel 3, and/or as other methods common in the art. The volume of the delivery would be dependant on the size of the chamber and the graduation of the measurement.

In various other embodiments, piston 9 delivers a measured dose to barrel 3. In various embodiments, such measured dose may be adjusted or changed depending on the needs of the application. The volume adjustments may be made by changing the size of piston 9 by a screw like member, installation of a different sized piston 9, and/or as other methods common in the art.

In particular, embodiments of the present invention comprise a nozzle/trigger relation as disclosed in the '899 patent, such that the spray from the nozzle may be adjusted and a proportional change in the draw rate of the fluidic substance may be maintained.

Various embodiments of the present invention further contemplate methods and/or processes.

In an embodiment of a, a process of the present invention comprises a process for dosing the feed of an animal with a medicament comprising the steps of:
loading a first portion of a system comprising a first portion a second portion and a third portion wherein the first portion is a receptacle capable of holding a viscous substance, the second portion is a quick disconnect cap assembly, and the third portion is a dose applicator for the viscous substance, wherein the second portion is removably attached to the first portion and the second portion is sealingly attached to the third portion, with a viscous substance comprising a medicament;
withdrawing a dose of the viscous substance from the receptacle; and,
dispensing the viscous substance from the dose applicator into the feed of an animal.
   Further processes of the present invention further comprise a step of disconnecting the third portion from the first portion, wherein the second portion comprises a male connector and a female connector, wherein the male portion removable attaches to the first portion and the female portion is sealingly attached to the third portion, wherein none of the viscous substance is allowed to leave the system. Further embodiments contemplate changing receptacles. Embodiments of such a process further comprise:

dispensing one dose of the viscous substance into the feed of swine until the receptacle is essentially empty of viscous substance;

disconnecting the male portion from the female portion; and,

reconnecting the female portion to a male portion removably attached to a receptacle comprising a viscous substance.

For a more complete understanding of the present invention, attention should be had to the following description of operation of a preferred embodiment.

### DESCRIPTION OF OPERATION OF A PREFERRED EMBODIMENT

Embodiments of the present invention can find utility in dosing a livestock. In an embodiment, a device of the present invention is used as a “top dress” in the feed for the application of an altrenogest for estrus synchronization of sexually mature gilts.

### EMBODIMENT OF METHOD OF OPERATION

In an embodiment, the dosing gun is used for delivering 6.8 ml of an altrenogest to swine. The user/operator would remove the shipping lid from the receptacle (shipping lid is used to cover receptacle during shipping) and replace it with the left side of the quick connection or male portion, which has the straw connected to it (the draw tube). The altrenogest may then be loaded in the receptacle or have been shipped preloaded (preloading may reduce the chances of leakage or accidental/incidental contact with the user/operator). The user/operator would attach the right side, or female portion of the quick connection device, to the male end by aligning the pin(s) within the female portion with the excerpts in the male portion/end and pushing together and turning to lock the at least two pieces together.

In this embodiment of the method of operation, a pliable tube is connected to the female portion. The pliable tube extends to the dosing device. The user/operator can squeeze the handle on the dosing device to fill the dose container. The loaded dose container may then be dispensed, thereby delivering 6.8 ml of the altrenogest solution.

When the user/operator is finished administering/delivering the medicament, in this example, the altrenogest, such as when the receptacle is empty, the female portion of the quick connection/quick coupling may be disconnected from the male portion and receptacle without allowing medicament/altrenogest to flow out of the female portion due to the anti backflow mechanism, spring, inside the quick coupling device. Likewise, any fluid in the receptacle will not flow out or through the male portion, even if the receptacle were inverted, due to the spring biasing the male portion closed when the female portion is removed.

For continued application, the male portion may be removed from the receptacle, the receptacle closed, such as with the shipping lid, and a new receptacle attached. This process may be repaetyed as often as desired.

When application is finished the applicator may be cleaned simply by flushing the various portions or by drawing clean water through the applicator to rinse the portions.

While the invention has been described in connection with specific embodiments thereof, it will be understood that it is capable of further modifications and the appended Claims are intended to cover any variations, uses, or adaptations of the invention following, in general, the principles of the invention and including such departures from the present disclosure as come within known or customary practice within the art to which the invention pertains and as may be applied to the essential features hereinbefore set forth whether now existing or after arising. Further, while embodiments of tile invention have been described with specific dimensional characteristics and/or measurements, it will be understood that the embodiments are capable of different dimensional characteristics and/or measurements without departing from the principles of the invention and the appended Claims are intended to cover such differences. Furthermore, all patents and other publications mentioned herein are herby incorporated by reference.

1. A dosing system for applying a viscous fluidic substance comprising a first portion a second portion and a third portion wherein the first portion is a receptacle capable of holding the substance, the second portion comprises a quick disconnect cap assembly capable of substantially preventing leakage of the substance being dispensed, and the third portion is a dose applicator for the substance, wherein the second portion comprises a male connector and a female connector, wherein the male portion removable attaches to the first portion and the female portion sealingly attaches to the third portion, wherein the first or the third portion can be removed from the system without allowing the viscous substance to leave the system.

2. The system of claim 1 wherein the second portion comprises a male connector and a female connector.

3. The system of claim 2 wherein the male portion removable attaches to the first portion.

4. The system of claim 2 wherein the female portion sealingly attaches to the third portion.

5. The system of claim 1 wherein the second portion further comprises a straw, whereby the straw extends into the viscous liquid contained within the receptacle of the first portion when the first portion is removable connected to the second portion.

6. The system of claim 1 wherein the viscous liquid is a medicament.

7. The system of claim 1 wherein the viscous liquid is a progesterone containing medicament.

8. The system of claim 1 wherein the third portion is a spray gun dosing applicator.

9. The system of claim 1 wherein the dosing applicator comprises a dispensing nozzle for dispensing the viscous substance, a dose container for containing a dose of the viscous substance, and a trigger connected between the second portion and the dose container for allowing the viscous substance to flow into the dose container from the receptacle.

10. The system of claim 9 wherein the trigger further comprises a piston.

11. The system of claim 1 further comprising a breather valve on the receptacle whereby a vacuum is prevented from forming within the receptacle.

12. The system of claim 3 wherein the second portion comprises a spring located within the male portion that biases the male portion to a closed position when the second portion is removed from the first portion.

13. The system of claim 1 further comprising a dosing chamber.

14. The system of claim 1 further comprising a spring in the male portion to close the male portion upon disconnection from the female portion.

15. The system of claim 1 further comprising a spring in the female portion to close the female portion upon disconnection from the male portion.

16. The system of claim 1 further comprising a spring in the male portion to close the male portion upon disconnection from the female portion and a spring in the male portion to close the male portion upon disconnection from the female portion, wherein the television on the spring in the male portion is less than the tension on the spring in the female portion, whereby the viscous fluid is allowed to flow more readily from the female portion through the male portion back to the receptacle.

17. A process for dosing the feed of an animal with a medicament comprising the steps of:
a. loading a first portion of a system comprising a first portion a second portion and a third portion wherein the first portion is a receptacle capable of holding a viscous substance, the second portion is a quick disconnect cap assembly, and the third portion is a dose applicator for the viscous substance, wherein the second portion is removably attached to the first portion and the second portion is sealingly attached to the third portion, with a viscous substance comprising a medicament;
b. withdrawing a dose of the viscous substance from the receptacle; and,
c. dispensing the viscous substance from the dose applicator into the feed of an animal.

18. The process of claim 17 further comprising a step of disconnecting the third portion from the first portion, wherein the second portion comprises a male connector and a female connector, wherein the male portion removable attaches to the first portion and the female portion is sealingly attached to the third portion, wherein none of the viscous substance is allowed to leave the system.

19. The process of claim 17 further comprising the steps of:
a. dispensing one dose of the viscous substance into the feed of swine until the receptacle is essentially empty of viscous substance;
b. disconnecting the male portion from the female portion; and,
c. reconnecting the female portion to a male portion removably attached to a receptacle comprising a viscous substance.

20. The process of claim 17 wherein the viscous substance is a progesterone containing medicament.

21. A dosing system comprising a receptacle means, a connection means, and a dispensing means,
wherein the first portion is a receptacle means capable of holding the substance, the second portion is a quick disconnect cap means capable of substantially preventing leakage of the substance being dispensed, and the third portion is a dose applicator means for the substance, wherein the second portion comprises a male connector and a female connector, wherein the male portion removable attaches to the first portion and the female portion sealingly attaches to the third portion, wherein the first or the third portion can be removed from the system without allowing the viscous substance to leave the system.

22. The device of claim 21 wherein the dosing applicator means comprises a dispensing nozzle means for dispensing the viscous substance, a dose container means for containing a dose of the viscous substance, and a trigger means connected between the second portion and the dose container for allowing the viscous substance to flow into the dose container from the receptacle means.
